(19) United States
(12) Patent Application Publication
(10) Pub. No.: US 2025/0083086 A1
(43) Pub. Date: Mar. 13, 2025

(54) METHOD AND DEVICE FOR SEPARATING A MATERIAL FROM A CARRIER GAS FLOW BY MEANS OF PARTIAL CONDENSATION

(71) Applicant: Messer SE & Co. KGaA, Bad Soden (DE)

(72) Inventors: Friedhelm Herzog, Krefeld (DE); Roberto Talluto, Bottrop (DE); Thomas Kutz, Brüggen-Born (DE); Steven Powell, Krefeld (DE)

(73) Assignee: Messer SE & Co. KGaA, Bad Soden (DE)

(21) Appl. No.: 18/728,433

(22) PCT Filed: Jan. 18, 2023
(86) PCT No.: PCT/EP2023/051134

§ 371 Date: Jul. 11, 2024

(30) Foreign Application Priority Data
Jan. 18, 2022 (DE) 10 2022 000 164.0

(51) Int. Cl. B01D 53/00; B01D 5/00; B01D 53/26

(52) U.S. Cl. CPC B01D 53/002; B01D 5/0012; B01D 5/009; B01D 53/265; B01D 2257/708; B01D 2259/65

(57) ABSTRACT

According to the invention, in the housing of a condenser, a carrier gas laden with a substance to be condensed out is fed to a first and a second heat exchanger surface in succession, where, in indirect contact with a heat transfer medium, it is brought to a temperature below the respective dew point temperature of the substance to be condensed out. An evaporation area, in which suitable heating means ensure that the carrier gas is heated up to a temperature above the dew point temperature, is provided between the first and the second heat exchanger surface in the flow path of the carrier gas. As a result, aerosols of the substance to be condensed out that have formed on the first heat exchanger surface evaporate and are at least partially condensed out on the second heat exchanger surface.

### CROSS-REFERENCE TO RELATED APPLICATIONS

The present application is the U.S. national stage application of international application PCT/EP2023/051134 filed Jan. 18, 2023, which international application was published on Jul. 27, 2023, as International Publication WO 2023/139127 A1. The international application claims priority to German Patent Application No. 10 2022 000 164.0,filed Jan. 18, 2022. The international and German applications are hereby incorporated by reference herein.

### FIELD

The invention relates to a method for separating a substance in gas or vapor form from a carrier gas stream by partial condensation. The invention also relates to a corresponding device.

### BACKGROUND

Such methods and devices are known. They are distinguished in that a carrier gas laden with a substance to be separated out is cooled down to a temperature below the dew point of the substance and the substance condensed in the process is then removed from the carrier gas stream. The carrier gas not condensed in the course of the method itself is, for example, air, nitrogen, hydrogen or a noble gas or a mixture of two or more of these gases. The carrier gas is frequently a gas stream which is laden with the gases or vapors that are to be separated out and comes from an industrial process (process gas). In the following text, the terms “process gas” and “carrier gas” are used synonymously. The carrier gas stream laden with substances to be separated out is also referred to in the following text as “carrier gas stream to be treated” or “process gas stream to be treated” and the carrier gas stream at least partially freed of the substances to be separated out is also referred to as “treated carrier gas stream” or “treated process gas stream”.

The gases or vapors to be separated from the carrier gas by condensation are in particular what are referred to as VOCs (Volatile Organic Compounds), or other substances of which the condensation temperature is above that of the carrier gas, such as water. It is unimportant whether the substances to be separated out are liquid or gaseous in ambient conditions. Moreover, a carrier gas stream to be treated may also be laden with multiple substances not all of which are to be separated, or which are to be separated in successive method steps.

Condensation methods known from the prior art utilize one or more apparatuses referred to as condensers. A condenser has a housing which usually has good thermal insulation and through which the carrier gas stream to be treated is guided along a flow path and brought into indirect contact there, on heat exchanger surfaces, with a cold heat transfer medium. In the process, the carrier gas is cooled down to a temperature below the dew point of the substance in gas or vapor form to be separated from the process gas. The substance at least partially condenses or freezes, and the resulting condensate can be separated from the gas stream. The heat transfer medium is for example a cryogenic cooling medium, such as liquid nitrogen. Such condensation apparatuses are widely used and are described, for example, in EP 1 743 688 A1, EP 0 275 472 A2, EP 0 988 879 A1, or DE 19 645 487 C1.

A problem with many known condensation methods is the formation of aerosols. When a carrier gas stream laden with a substance impinges on a surface which has a temperature considerably lower than the dew point temperature of the substance, aerosols are produced in the surrounding area of the surface which contain the substance to be condensed out and can no longer be separated from the carrier gas stream in the condensers themselves. The result of this is a higher residual loading of the carrier gas streams treated than would be expected due to the carrier gas temperature reached in the condenser.

To avoid or reduce aerosol formation, it is known to design condensation methods such that only temperature differences between the carrier gas and the cooling surfaces that are as small as possible arise in the flow path of the condenser. However, either this leads to very large and complex apparatuses, or it is necessary to accept losses in the efficiency of the method.

A method and a device for low-aerosol partial condensation are also known from EP 1 602 401 A2. A carrier gas stream to be treated is guided through two condensers connected one behind the other, in each of which it is brought into indirect thermal contact with a cryogenic heat transfer medium. A heater, by means of which the carrier gas stream is brought to a temperature above the condensation temperature of a substance to be removed from the carrier gas, is arranged between the condensers. As a result, the aerosols that have formed in the first condenser evaporate. In the subsequent condenser, cooling back down below the dew point of the substance in the carrier gas takes place, as a result of which at least a considerable proportion of the substance to be separated out can be separated from the former aerosols. The aerosol fraction in the treated carrier gas stream is drastically minimized in this way. The method described in that document has proven successful but is comparatively complex to construct and maintain.

### SUMMARY

An object of the present invention is therefore to specify a possible way of separating substances in gas or vapor form from a carrier gas stream by partial condensation, in the case of which the aerosol loading of the treated carrier gas stream is reduced in comparison with condensation methods according to the prior art, and which can be realized with relatively straightforward means.

This object is achieved by methods and devices having the features recited in the claims.

According to the invention, the carrier gas thus flows inside the housing of a condenser through a flow path on which it is brought into indirect thermal contact with a heat transfer medium, for example liquid or cold gaseous nitrogen, on at least two heat exchanger surfaces in succession. On a first heat exchanger surface, it is cooled down in the region of the first heat exchanger surface to a first temperature T₁ below the dew point temperature TT₁ of the substance to be condensed out. In the process, at least a first proportion of the quantity of the substance present in the carrier gas stream condenses out and in the form of liquid condensate is discharged and collected, for example in a condensate tank or inside the condenser housing in the form of a condensate bath. Then, in the flow path the carrier gas flows through an evaporation area, in which a temperature T₂ above the dew point temperature TT₂ of the substance in this region is maintained. In the process, the aerosols present in the carrier gas stream at least partially evaporate. On a second heat exchanger surface, which follows the evaporation area in the flow path, the carrier gas is cooled down again, this time to a third temperature T₃ below the dew point temperature TT₃ of the substance to be condensed out, in the region of the second heat exchanger surface. As a result, on the second heat exchanger surface a significant proportion of the substance is deposited from the previously evaporated aerosols in the form of liquid condensate and is also discharged, for example into the condensate bath. In general, therefore, it holds true that T₃<T₁<T₂, i.e. the temperature of the carrier gas on the second heat exchanger surface is lower than the temperature of the carrier gas on the first heat exchanger surface. The temperature of the heat transfer media in the first and the second heat exchanger may be the same or different; what is essential for the invention, however, is that the carrier gas in the region of the two heat exchangers is brought to a temperature below the respective dew point temperature in each case.

The arrangement of the first and second heat exchanger surfaces and the evaporation area inside the same condenser housing has the effect that the carrier gas flowing through is cooled down and heated up again very quickly in succession within a relatively short displacement distance. For aerosol droplets that have formed during the condensation of the substance in the surrounding area of the first heat exchanger, there is therefore only very little time available for them to coagulate into larger and more stable droplets; owing to their relatively small diameter, they evaporate very quickly in the evaporation area.

Advantageously, the method may also be carried out in multiple stages, by cooling down the carrier gas as it flows through the flow path repeatedly in succession on a first heat exchanger surface or a group of first heat exchanger surfaces, then heating it up in a evaporation area and cooling it down again on a second heat exchanger surface or a group of second heat exchanger surfaces. It is also possible to choose to guide the flow such that a second heat exchanger surface (or a group of second heat exchanger surfaces) arranged downstream of an evaporation area at the same time act as a first heat exchanger surface (or group of first heat exchanger surfaces) for a subsequent evaporation area. Such a configuration can be realized particularly easily for example in that the carrier gas in the condenser housing is forced into a meandering course by conventional baffle plates and in the process periodically flows around multiple tube bundles which are arranged in a straight line, serve as first and/or second heat exchanger surfaces, and are cooled down by the heat transfer media guided through them. Evaporation areas equipped with means for heating up the carrier gas are provided between two such heat exchanger surfaces or between two groups of heat exchanger surfaces; these evaporation areas are, for example, a further heat exchanger, for instance a tube bundle, through which a correspondingly hotter heat transfer medium flows. If the method is carried out in multiple stages, a large temperature difference may also be allowed between the heat transfer media on the heat exchanger surfaces and the carrier gas, since the aerosols forming to a comparatively high extent at the start are at least largely eliminated in the subsequent method stages. This increases the efficiency of the method and enables a compact structure of a corresponding condensation device.

The temperature of the carrier gas in the evaporation area can be controlled in particular by means of a, for example, electric heater and/or by heat from a radiation source. However, it is particularly preferred if the carrier gas in the evaporation area is heated by means of a heat exchanger surface (evaporation heat exchanger surface) on which the carrier gas is brought into indirect thermal contact with a heat transfer medium, the temperature of which is above the dew point temperature of the substance to be condensed out in the carrier gas. Moreover, it is advantageous if the temperature in the evaporation area is regulated by suitable means on the basis of measured parameters, such as a residual loading of the treated carrier gas.

The heat transfer medium used on such an evaporation heat exchanger surface may be a heat transfer medium which is different to or the same as that also used on the first and/or the second heat exchanger surface. For the heating up of the carrier gas in the evaporation area on the evaporation heat exchanger surface, the temperature of this heat transfer medium must be correspondingly controlled.

The temperature of a heat transfer medium used on the evaporation heat exchanger surface can be controlled for example by means of an electric or otherwise operated heater. A preferred configuration, however, provides that at least a partial stream of the heat transfer medium used on the first and/or the second heat exchanger surface is brought into thermal contact with the collected condensate in the condensate bath after flowing through this/these heat exchanger surface/surfaces and then fed to the evaporation heat exchanger surface. The condensate is at a temperature which is naturally above the required dew point temperature. For example, the condensate collected on the first and/or the second and/or a following heat exchanger surface is temporarily stored in a condensate tank, which may be arranged inside or outside the condenser housing. A heat exchanger, on which the heat transfer medium discharged from the first and/or second heat exchanger surface is brought into indirect thermal contact with the condensate, is preferably arranged in this condensate tank.

This configuration is advantageous in particular when the method according to the invention is used in a device in the case of which the condensate is collected inside the condenser housing, for example a sump of the housing with formation of a condensate bath, which thus does not involve any fluidic separation of the collected condensate from the carrier gas stream. Such arrangements, in particular in the case of low-boiling substances, have the problem that the condensate completely or partially re-evaporates and re-enters the carrier gas owing to a thermal fluctuation or an input of heat from the outside. Owing to the thermal contact of the heat transfer medium from the first and/or the second heat exchanger with the condensate in the condensate bath, its temperature is preferably lowered far enough below its boiling temperature that the probability of re-evaporation is at least reduced, or re-evaporation is entirely prevented, even in the case of any thermal fluctuations present in the carrier gas stream or inputs of heat via the walls of the apparatus. In this way, it is possible to omit in particular an active cooling of the condensate by means of a cooler, or at least to perform this active cooling to a lesser extent.

Depending on the case, however, it can also prove expedient to heat up the condensate and/or the heat transfer medium guided to the heat exchanger in the condensate bath, for example by means of an electric heater. The heating prevents excessive cooling or even freezing of the condensate, in particular when a large mass flow of heat transfer medium is guided through the heat exchanger in the condensate tank.

The heat transfer media used on the first, the second and/or optionally further heat exchanger surfaces can be taken entirely or partially from different sources, for example the heat transfer media may be media which comprise different materials or are kept at different temperatures. With preference, however, the cooling medium used on the first heat exchanger surface and the cooling medium used on the second heat exchanger surface come from a common source, which is for example a tank for liquid nitrogen. If the evaporation area is heated up by means of a heat transfer medium on an evaporation heat exchanger surface, it is advantageous, especially for economic reasons, to also use the same heat transfer medium for this, which is to say for example nitrogen, which comes from the same source as the other heat transfer media.

It is particularly advantageous to carry out the method in a way in which a liquefied gas, such as liquid nitrogen (LIN), liquid oxygen (LOX) or liquid natural gas (LNG) is used as heat transfer medium, which at least partially evaporates on the first and/or the second heat exchanger surface owing to the thermal contact with the carrier gas. As a result, the enthalpy of evaporation of the heat transfer medium is additionally utilized to cool down the carrier gas.

The heat transfer medium used on the first and/or the second heat exchanger surface is preferably a cryogenic heat transfer medium, for example liquid nitrogen (LIN) or a different cryogenically liquefied gas. However, it is also possible to use other liquid or gaseous heat transfer media that can be brought to a temperature suitable for condensing out the respectively selected substances to be separated out in the carrier gas stream, such as brine, cooling water or thermal oil.

Since the treated carrier gas is at a sometimes very low temperature after the thermal contact with the heat transfer medium on the second or a later heat exchanger surface, it has proven to be advantageous in many cases if at least a partial stream of the treated carrier gas is brought into thermal contact with the untreated carrier gas, in order to utilize a still-present residual cold to cool down the untreated carrier gas. This is effected for example by means of an additional heat exchanger surface (recuperator), for example in the form of a tube bundle, which is arranged inside or outside the condenser housing and on which at least a partial stream of the treated carrier gas is brought into indirect thermal contact with the untreated carrier gas stream.

Moreover, the method according to the invention also makes it possible to treat carrier gas streams laden with multiple substances not all of which are to be separated, or which are to be separated at the same time or in successive steps in the way described above.

The object of the invention is also achieved by a device having the features recited in the claims.

A device according to the invention thus comprises a condenser housing, through which a flow path extends from a process gas inlet to a process gas outlet, through which flow path a carrier gas laden with a substance to be condensed out is guided when the device is in use. The flow path is not necessarily a straight path; rather, the flow path may also be designed such that the carrier gas in the housing is deflected one or more times and/or forced into a meandering course by means of suitable auxiliaries, such as baffle plates. Arranged in this flow path one behind another are two or more heat exchanger surfaces, which are intended for cooling down the carrier gas to a temperature below the dew point temperature of a substance to be condensed out in the carrier gas and are in each case for example a tube, a tube bundle or a cooling coil or a portion of a tube, tube bundle or cooling coil. Provided between at least two of the heat exchanger surfaces—referred to here as first and second heat exchanger surface—is an evaporation area in which suitable means can be used to heat up the carrier gas stream to a temperature which is above the dew point temperature of the substance to be condensed out in this evaporation area. The means for heating up the carrier gas in the evaporation area are for example an electric heater or a heat exchanger (evaporation heat exchanger) through which a correspondingly temperature-controlled heat transfer medium flows. The device is additionally equipped with a unit for collecting and discharging liquid condensate. This unit preferably comprises one or more condensate tanks which are assigned to one or more heat exchangers and in which the condensate collected on the respective heat exchanger is at least temporarily stored; the one or more condensate tanks may be arranged inside or outside the housing; the condensate tank may be in particular the sump of the condenser housing.

When the device according to the invention is in use, the carrier gas is brought into indirect thermal contact with a heat transfer medium on the two heat exchanger surfaces in succession and in the process is cooled down to a temperature below the respective dew point temperature of the substance to be condensed out. By heating the carrier gas in the evaporation area between two heat exchanger surfaces, the carrier gas is heated up to a temperature above the dew point temperature existing there of the substance to be condensed out. As a result, aerosols present in the carrier gas and containing the substance to be condensed out evaporate. The substance which has thus returned to gas form is condensed again when the carrier gas is cooled down on the second, or a subsequent heat exchanger surface and is then discharged at least partially in the form of liquid condensate.

The device according to the invention is distinguished by a compact and relatively straightforward structure and is suitable for effectively reducing aerosols in the treated carrier gas. The device is thus suitable in particular for carrying out the method according to the invention.

In an advantageous refinement of the device according to the invention, more than two heat exchanger surfaces for cooling down the carrier gas, along which heat exchange surfaces carrier gas flows in succession, are arranged one behind the other in the flow path of the carrier gas, wherein evaporation areas for heating up the carrier gas in the interim are provided at least between some of the heat exchanger surfaces. For example, a group consisting of two or more first heat exchanger surfaces, arranged one behind another in the flow path, can be arranged in the flow path upstream of an evaporation area equipped with means for heating up the carrier gas, and/or a group of two or more second heat exchanger surfaces arranged one behind another in the flow path can be arranged in the flow path downstream of such an evaporation area, wherein the carrier gas is respectively cooled down on the heat exchanger surfaces and the previously cooled-down carrier gas is heated up in the evaporation area. It is similarly possible to provide in the flow path a sequence of two or more evaporation areas with means for heating up the carrier gas, upstream of which evaporation areas (as seen in the flow direction of the carrier gas) in each case a first heat exchanger surface or a group of first heat exchanger surfaces is provided, and downstream of which evaporation areas in each case a second heat exchanger surface or a group of second heat exchanger surfaces is provided. The second heat exchanger surface or the group of second heat exchanger surfaces may also be arranged directly upstream of an evaporation area, so that it or they act(s) as first heat exchanger or group of first heat exchangers with respect to this evaporation area. In general, first heat exchanger surface(s) should be understood here to mean one or more heat exchanger surfaces which is/are arranged upstream of an evaporation area in the flow path of the carrier gas and second heat exchanger surfaces should be understood to mean one or more heat exchanger surfaces which is/are arranged downstream of an evaporation area in the flow path.

Expediently, the first heat exchanger and/or the second heat exchanger is in the form of a shell and tube heat exchanger, through which a heat transfer medium flows. The first heat exchanger surface and/or the second heat exchanger surface and/or optionally one or more further heat exchanger surfaces are thus respectively tube bundles or a portion of a tube bundle through which a heat transfer medium flows. The same or different heat transfer media can be used on the two heat exchanger surfaces.

A particularly advantageous embodiment of the device according to the invention provides that the flow path of the carrier gas is guided in meandering fashion around respective mutually parallel tube bundles, acting as heat exchanger surfaces, of the first and the second heat exchanger. A meandering flow path can be realized in a conventional way, for example by suitable baffle plates, so-called “baffles”, which are arranged inside the condenser housing. With each change in direction of the flow path, the carrier gas flows along portions of the respective tube bundle and the result is a cooling of the carrier gas. Evaporation areas, in which means for heating up the carrier gas are arranged, are provided between at least some of the portions. As it flows through the flow path, the carrier gas is thus repeatedly cooled down, heated up and cooled down again in succession. Such a multi-stage arrangement makes it possible to almost completely eliminate aerosols present in the carrier gas and consisting of the substance.

Moreover, the tube bundles of all said heat exchangers may also be U-shaped and/or be connected to deflection chambers in a top space of the condenser housing, in order to enlarge the flow path of the respective heat transfer medium in the condenser housing and the contact surface area with the carrier gas.

The means for heating up the carrier gas in the evaporation area preferably comprise an evaporation heat exchanger equipped with a feed line and a discharge line for a heat transfer medium and an evaporation heat exchanger surface. In this case, in structural terms, this is actually a third heat exchanger surface, which is arranged in the flow path between the two other heat exchanger surfaces but is operated at a higher temperature than they are.

In an advantageous refinement of this configuration, the feed line for the heat transfer medium of the evaporation heat exchanger is fluidically connected to the discharge line for the heat transfer medium of the first and/or the second heat exchanger, wherein means for heating up the heat transfer medium are provided in the discharge line for the heat transfer medium of the first and/or the second heat exchanger, upstream of the evaporation heat exchanger. The first and/or the second heat exchanger and the evaporation heat exchanger are thus operated with the same heat transfer medium, which however is heated up after flowing through the first and/or the second heat exchanger and before flowing through the evaporation heat exchanger.

The aforesaid means for heating the heat transfer medium preferably comprise a condensate bath for the liquid condensate separated out in the device and a heat exchanger surface which is arranged in the condensate bath and preferably likewise is a tube bundle or a portion of a tube bundle. On the heat exchanger surface, the heat transfer medium flowing out of the first and/or the second heat exchanger can be brought into thermal contact with the condensed-out substance before being fed to the evaporation heat exchanger. The condensate bath is preferably accommodated inside the condenser housing, for example in a collection tank or in the sump of the condenser housing. For example, one or more tube bundles which is/are curved in a U shape and dip with its/their curved portion into a condensate bath arranged inside the condenser housing are provided as heat exchanger surfaces. As a result of the thermal contact with the condensate bath on the one or more U-shaped tube bundle portions, the heat transfer medium is preferably heated until its temperature is above the dew point temperature of the substance to be condensed out in the carrier gas stream and thus can be used as heat transfer medium for heating up the carrier gas in the evaporation area. At the same time, the condensate bath is cooled down, which reduces the risk of re-evaporation of the condensate from the condensate bath.

Means for controlling the temperature of the condensate are preferably provided in the condensate bath. Depending on the respective object, these means may be a heater and/or a cooler.

A likewise advantageous refinement of the invention provides that a further heat exchanger, here referred to as cryogenic heat exchanger, is arranged downstream—as seen in the flow direction of the carrier gas—of the second heat exchanger. On the cryogenic heat exchanger, the process gas is cooled down further, preferably to a temperature lower than the temperature of the process gas on the second heat exchanger. As a result, a still-present residual loading of substance to be condensed out is at least largely eliminated. Since aerosols are present in the carrier gas to only a very small extent downstream of the second heat exchanger (or a subsequent heat exchanger), an evaporation area is no longer necessary in the region of the cryogenic heat exchanger. The cryogenic heat exchanger is preferably in the form of a shell and tube heat exchanger, on which the carrier gas is brought into thermal contact with a heat transfer medium fed in the form of liquefied gas, and this heat transfer medium evaporates in the process. The evaporated heat transfer medium is subsequently used for example as gaseous heat transfer medium in the first and/or the second heat exchanger and/or in the evaporation heat exchanger.

A once again advantageous embodiment of the invention provides that the heat exchanger surfaces of the first and/or the second heat exchanger and of the evaporation heat exchanger are in the form of tube bundles, which extend concentrically with one another at least in one portion of the condenser housing, wherein the tube bundles of the first and/or the second heat exchanger are arranged at least partially radially on the inside of the tube bundles of the evaporation heat exchanger. In this case, the evaporation heat exchanger, through which relatively hot heat transfer medium flows, acts as a cooling screen for shielding the first and/or the second heat exchanger.

### BRIEF DESCRIPTION OF THE DRAWINGS

Exemplary embodiments of the invention are to be explained in more detail on the basis of the drawings, in which:

FIG. 1 shows a schematic view in a longitudinal section of a device according to the invention in a first embodiment.

FIG. 2 shows a schematic view in a longitudinal section of a device according to the invention in a second embodiment.

FIG. 3 shows a schematic view in a longitudinal section of a device according to the invention in a third embodiment.

FIG. 4 shows a schematic view in a longitudinal section of a device according to the invention in a fourth embodiment.

### DETAILED DESCRIPTION

In the exemplary embodiments of the invention that are shown below, components that are the same or have the same effect are characterized by the same reference numerals.

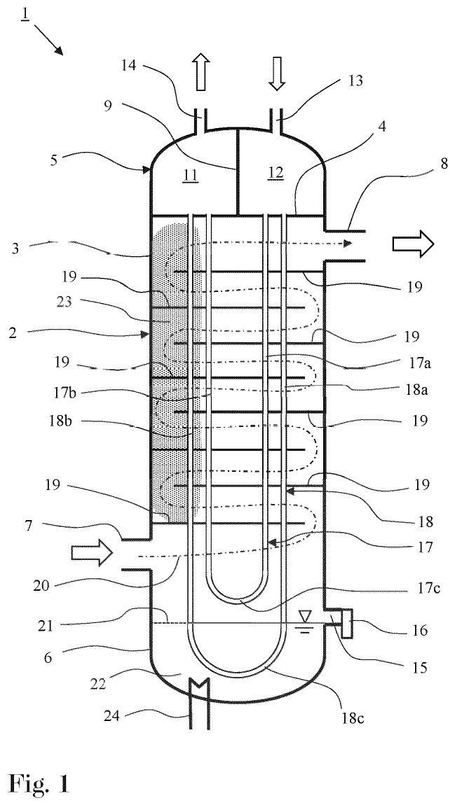

The device 1, shown in FIG. 1, for separating a substance in gas or vapor form from a carrier gas stream by partial condensation comprises a condenser housing 2, which is equipped with walls that have good thermal insulation. The condenser housing 2 comprises a cylindrical central portion 3, a top space 5 fluidically separated therefrom by a tube bottom 4, and a sump 6. A carrier gas inlet 7 leads into the central portion 3 in a geodetically lower portion and a carrier gas outlet 8 leads into said central portion in a geodetically upper portion. The top space 5 is subdivided into two mutually fluidically separate subspaces 11, 12 by a vertical partition wall 9. A feed line 13 for a liquid or gaseous heat transfer medium leads into the subspace 12, whereas a discharge line 14 for heat transfer medium leads into the subspace 11. The sump 6 intended to accommodate a liquid condensate is equipped with an overflow 15, adjoining which is a gas barrier 16 for preventing an undesired passage of gas, for example a siphon or the like.

The subspaces 11, 12 of the top space 5 are fluidically connected to one another via two U-shaped tube bundles 17, 18, which are indicated only by individual tubes in the exemplary embodiments shown here for the sake of clarity but in fact consist of a plurality of parallel tubes. The tube bundles 17, 18 have respective perpendicular tube bundle portions 17a, 17b; 18a, 18b, which are fluidically connected to one another at their lower ends via a curved tube bundle portion 17c, 18c or by tube bottoms (not shown here). The tube bundles 17, 18 extend down to different depths in the condenser housing 2; while the tube bundle 17 goes no deeper than down to a level just above the overflow 15, the tube bundle 18 goes deep into the sump 6 below the level of the overflow 15. Furthermore, a plurality of baffle plates 19 (so-called “baffles”), which force a gas flowing from the carrier gas inlet 7 to the carrier gas outlet 8 into a meandering flow path 20 (indicated here by a dash-dotted line) inside the central portion 3, are arranged in the central portion 3 of the condenser housing 2.

When the device 1 is in operation, a carrier gas (process gas) laden with a substance to be condensed out flows into the condenser housing 2 via the carrier gas inlet 7 and leaves same at the carrier gas outlet 8. The gas barrier 16 prevents process gas flowing out via the overflow 15. In the central portion 3, the flow path 20 of the process gas meanders, wherein the process gas comes into contact with the tube bundle portion 18b, 17b, 17a, 18a (in the case of a flow direction from left to right) or 18a, 17a, 17b, 18b (in the case of a flow direction from right to left) in succession after each change in direction. At the same time, a heat transfer medium, which is cold compared to the process gas, is fed via the subspace 12 of the top space 5, from which it flows into the tube bundles 17, 18. If a liquefied gas, such as liquid nitrogen, is used as heat transfer medium, the stream of the heat transfer medium guided through the tube bundles 17, 18 is preferably set such that the heat transfer medium also evaporates in the tube bundle portions 17a, 18a owing to the thermal contact with the process gas. The heat transfer medium flows in parallel through the tube bundles 17, 18 to the subspace 11 and is discharged via the discharge line 14.

As a result of the thermal contact of the process gas with the heat transfer medium in the tube bundles 17, 18, the process gas is cooled down at least at some locations in the flow path 20 to a temperature below the dew point of a substance (in the following text also referred to as “substance to be condensed out”) in gas or vapor form present in the process gas. A liquid condensate forms on the surfaces of the tube bundles 17, 18, which collects in the sump 6 to form a condensate bath 22 as a result. The condensate bath 22 rises up to a maximum level 21, which is established by the position of the overflow 15. As soon as this level is reached, any further condensate flowing in is discharged via the overflow 15 and disposed of or fed for further exploitation.

Since the curved tube bundle portion 18c of the tube bundle 18 extends underneath the level 21, the heat transfer medium guided through the tube bundle 18 comes into thermal contact there with the liquid condensate bath 22 and heats up as a result; at the same time, the condensate bath 22 in the sump 6 is cooled down. The heat transfer medium guided through the tube bundle portion 18b is therefore at a higher temperature than the heat transfer medium guided through the tube bundle portions 17a, 17b and 18a.

In a right-to-left portion of the flow path 20, the process gas flows around the tube bundle portions 18a, 17a and 17b in succession. Owing to the low temperatures prevailing in the tube bundle portions 18a, 17a, 17b, the process gas is cooled down to a temperature below the dew point of the substance to be condensed out. In the process, in addition to the liquid condensate, undesired aerosols that contain the substance to be condensed out and are entrained by the carrier gas stream also form. The flow path 20 of the process gas then crosses the tube bundle portion 18b twice, one time after the other, this tube bundle portion being at a comparatively higher temperature owing to the prior thermal contact with the condensate in the sump 6. In an evaporation area 23 around the tube bundle portion 18b (indicated by a gray area here), the process gas is heated up as a result beyond the dew point temperature of the substance to be condensed out. The aerosols that had formed beforehand at least largely evaporate there and the substance to be condensed out that transitions back into gas form forms a homogeneous gas mixture again with the process gas. After this, the process gas flows around the tube bundle portions 17b, 17a and 18a again (but in a different loop of the meandering flow path), wherein it in turn is cooled down to a temperature below the dew point temperature of the substance and the substance condenses again on the surface of the tube bundle portions 17a, 17b, 18a. The tube bundle portions 17a, 17b, 18a thus serve twice as heat exchanger surfaces for cooling down the process gas, once before and once after it has flowed through the evaporation area 23. A large proportion of the substance present in the previously evaporated aerosols can in this way be separated from the process gas and fed to the condensate in the sump 6.

An optionally present, for example electrically operated heater 24 makes it possible to control the temperature of the condensate as required, in order in particular to prevent the condensate from being excessively cooled down or frozen owing to the thermal contact with the heat transfer medium on the tube bundle portion 18c. As an alternative or in addition to this, although it is not shown here, it is also possible to heat up the heat transfer medium before it flows through the tube bundle portion 18c, or hotter heat transfer medium can be admixed with the heat transfer medium in the tube bundle portion 18c. Instead of or in addition to the heater 24, it is also possible for a cooler for cooling down the condensate to be present, in order to prevent the condensate from re-evaporating, for example in the case of an input of heat from the outside and/or not enough cooling by the heat transfer medium.

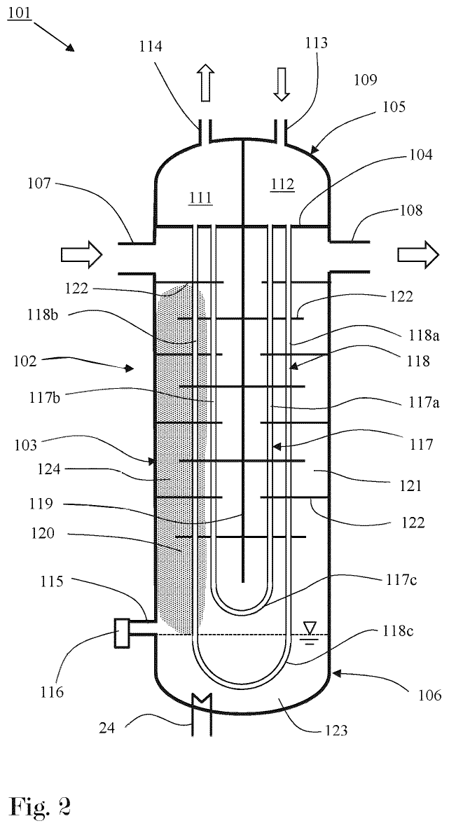

The exemplary embodiment according to FIG. 2 is distinguished from the exemplary embodiment described above by a longer flow path of the process gas and thus by improved utilization of the cold of the heat transfer medium.

Similarly to the device 1, the device 101 shown in FIG. 2 has a vertically arranged condenser housing 102 with good thermal insulation. The condenser housing 102 is equipped with a central portion 103, a top portion 105 fluidically separated therefrom by a tube bottom 104, and a sump 106. A carrier gas inlet 107 and a carrier gas outlet 108 lead into an upper area, i.e. one which is adjacent to the tube bottom 104, of the central portion 103. The top space 105 is divided into two mutually fluidically separate subspaces 111 and 112 by a vertical partition wall 109, wherein a feed line 113 for a heat transfer medium leads into the subspace 112 and a discharge line 114 for a heat transfer medium leads into the subspace 111. The sump 106 is equipped with an overflow 115 and a gas barrier 116.

The subspaces 111, 112 of the top space 105 are fluidically connected to one another via two U-shaped tube bundles 117, 118, which are also indicated only by individual tubes here. The tube bundles 117, 118 have respective perpendicular tube bundle portions 117a, 117b; 118a, 118b, which are fluidically connected to one another at their lower ends via a curved tube bundle portion 117c, 118c (as shown here) or by tube bottoms. The tube bundles 117, 118 extend to different depths in the condenser housing 102; while the tube bundle 117 goes no deeper than down to a level just above the overflow 115, the tube bundle 118 goes deep into the sump 106 underneath the level of the overflow 115.

By contrast to the device 1, the central portion 103 of the condenser housing 103 is subdivided into two partially mutually fluidically separate portions 120, 121 by a partition wall 119. The partition wall 119 extends vertically down from the tube bottom 104 to just above the sump 106 and forces a process gas fed via the carrier gas inlet 107 to follow a downwardly directed flow path in the portion 120 and, by contrast, an upwardly directed flow path in the portion 121, which is to say in each case in a counterflow arrangement with respect to the heat transfer medium flowing through the tube bundles 117, 118 from the feed line 113 to the discharge line 114. In addition, baffle plates 122 which force the process gas to follow a respective meandering course are provided in both portions 120, 121.

The portion 120 serves in particular to cool down the process gas to a temperature below the dew point temperature of a substance to be condensed out and to remove aerosols that have formed in the process. For this, the process gas in the portion 120 flows in succession, always alternately, around the tube bundle portions 117b and 118b of the tube bundles 117, 118. Upon contact with the heat transfer medium in the tube bundle portion 117b, the process gas is cooled down to a temperature below the dew point temperature of the substance to be condensed out. The liquid condensate which accumulates on the surface of the tube bundle portion 117b in the process flows via the baffle plates 122 to the sump 106 and collects there to form a condensate bath 123.

The heat transfer medium, which dips into the condensate bath 123 in the tube bundle portion 118c and is heated up there in thermal contact with the condensate, of the tube bundle 118 is at a higher temperature in the tube bundle portion 118b than the heat transfer medium in the tube bundle portion 117b is. Therefore, the process gas cooled down beforehand on the tube bundle portion 117b is heated up on thermal contact with the heat transfer medium in the tube bundle portion 118b, specifically to a temperature above the dew point temperature of the substance to be condensed out. The heat transfer is effected by contact between the process gas and the tube bundle portion 118b and/or by heat radiation emitted by the tube bundle portion 118b. In this way, an evaporation area 124, in which aerosols produced upon prior cooling of the process gas and containing the substance to be condensed out evaporate, lies respectively radially around the tubes of the tube bundle portion 118b. The substance which thus transitions back to gas form condenses out at least partially in liquid form upon subsequent renewed contact with the tube bundle portion 117b.

From the portion 120, the process gas flows into the portion 121 of the central portion 103. In this area, there is no longer any heating in the interim, and instead the process gas is cooled down continuously to a low temperature in thermal contact with the tube bundle portions 117a, 118a, which act as a cryogenic heat exchanger in this respect. If a liquefied gas is used as heat transfer medium, the tube bundle portions 117a, 118a additionally preferably serve to evaporate the liquid heat transfer medium fed via the feed line 113.

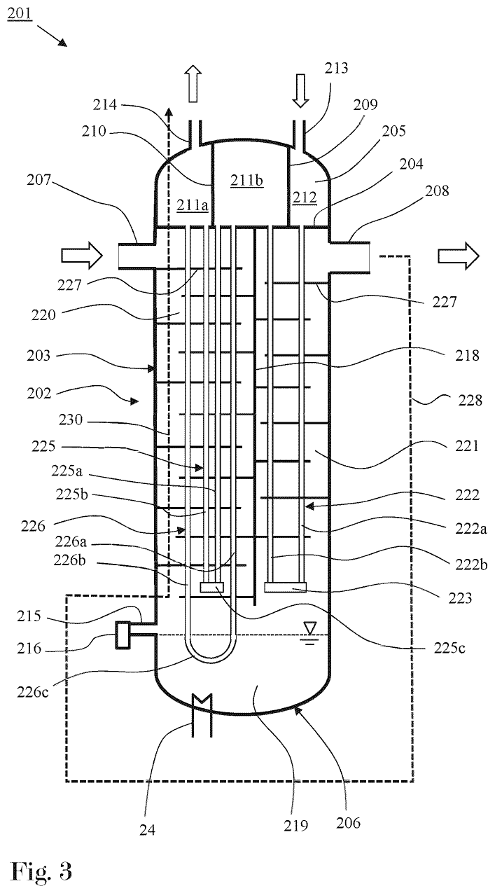

The exemplary embodiment shown in FIG. 3 of a device 201 according to the invention has a similarly vertically arranged condenser housing 202 provided with thermal insulation, which condenser housing is subdivided into a central portion 203, a top portion 205 fluidically separated therefrom by a tube bottom 204, and a sump 206.

A carrier gas inlet 207 and a carrier gas outlet 208 lead into an upper portion of the central portion 203. In this exemplary embodiment, the top space 205 is subdivided into three mutually fluidically separate subspaces 211a, 211b, 212 by two vertical partition walls 209, 210, wherein a feed line 213 for a heat transfer medium leads into the subspace 212 and a discharge line 214 for a heat transfer medium leads into the subspace 211a. The subspace 211b does not have a line connection to outside the housing 202. The sump 206 is-as in the previous exemplary embodiments-equipped with an overflow 215 and a gas barrier 216.

A partition wall 218, which extends inside the central portion 203 from the tube bottom 204 to just above the sump 206 and a condensate bath 219 present in the sump 206 when the device 201 is in operation, divides the central portion 203 into two functional portions 220, 221, wherein the portion 220 serves for removing the aerosols from the process gas, while in portion 221, in which only a few aerosols are still present in the process gas, a still-present residual loading in the process gas is at least largely eliminated.

A tube bundle 222, which fluidically connects the two subspaces 212 and 211b to one another, extends through the portion 221. The tube bundle 222 comprises two mutually substantially perpendicular and parallel tube bundle portions 222a, 222b, and also a tube bottom 223 connecting them at their ends opposite the tube bottom 204. The tube bottom 223 hangs freely from the tube bundle portions 222a, 222b and is arranged above the condensate bath 219. As an alternative to the suspended tube bottom 223 shown here, it is also possible to provide a U-shaped tube bundle portion (similar to tube bundle 226c).

Two U-shaped tube bundles 225, 226 fluidically connecting the subspaces 211a and 211b of the top space 205 to one another are arranged in the portion 220. The tube bundles 225, 226 each have perpendicular tube bundle portions 225a, 225b; 226a, 226b, which are fluidically connected to one another at their lower ends by a tube bottom 225c or via a curved tube bundle portion 226c. The tube bundles 225, 226 extend down to different depths in the condenser housing 202; while the tube bundle 225 goes no deeper than down to a level above the overflow 215, the tube bundle 226 dips into the liquid condensate bath 219 by way of the tube bottom portion 226c.

Furthermore provided both in portion 220 and in portion 221 are a plurality of baffle plates 227, which in the portions 220, 221 force a respective gas flowing from the carrier gas inlet 207 to the carrier gas outlet 208 inside the central portion 203 into a meandering flow path extending downstream in the portion 220 and upstream in the portion 221.

When the device 201 is in operation, a process gas laden with a substance to be condensed out flows into the condenser housing 202 via the carrier gas inlet 207 and leaves same at the carrier gas outlet 208. The gas barrier 216 prevents process gas flowing out via the overflow 215. In the portion 220, the process gas is forced into a meandering flow path by the baffle plates 227, wherein the process gas comes into contact with the tube bundle portion 226b, 225b, 225a, 226a (in the case of a flow direction from left to right) or 226a, 225a, 225b, 226b (in the case of a flow direction from right to left) in succession after each change in direction. At the same time, a cold heat transfer medium present in the subspace 211b is fed into the tube bundle portions 225a, 226a. The heat transfer medium flows in parallel through the tube bundles 225, 226 to the subspace 211a and is discharged via the discharge line 214. Upon thermal contact with the tube bundle portions 226a, 225a, 225b, the process gas is cooled down to a temperature below the dew point temperature of the substance to be condensed out. In the process, a liquid condensate is produced on the surface of the tube bundle portions 226a, 225a, 225b, which liquid condensate flows off to the sump 206 and there forms the condensate bath 219.

Since the curved tube bundle portion 226c of the tube bundle 226 extends through the condensate bath 219, the heat transfer medium guided through the tube bundle 226 comes into thermal contact there with the liquid condensate and heats up in the process; at the same time, the condensate in the sump 206 is cooled down. The heat transfer medium guided through the tube bundle portion 226b is therefore at a higher temperature than the heat transfer medium guided through the tube bundle portions 225a, 225b and 226a is. As a result, after each change in direction of the process gas in the region of the tube bundle portion 226b heating of the process gas cooled down beforehand on the tube line portions 225a, 225b and 226a occurs, and aerosols of the substance to be condensed out that had formed beforehand evaporate again. The heat transfer medium guided through the tube line portions 225b, 226b is then discharged via the subspace 211a and the discharge line 214.

The process gas then flows into the portion 221 and there is cooled down owing to the thermal contact with the heat transfer medium that is fed via the feed line 213, fed into the tube bundle portion 222a via the subspace 212 and guided through the tube bundle 222. The heat transfer medium is, for example, a cryogenically liquefied gas which evaporates on thermal contact with the process gas on the tube bundle 222. The tube bundle 222 thus corresponds to a cryogenic heat exchanger, on which the process gas is cooled down further, in order to eliminate to the greatest possible extent, by way of condensing it out, any still-present residual loading with the substance to be condensed out. Depending on the dew point and melting point of the one or more substances to be condensed out, it is also possible for the substance or the substances to freeze out in this region on the tubes of the tube bundle portions 222a, 222b; in this case, the device 201 must be defrosted from time to time in order to maintain full efficiency. Since there are as good as no aerosols in the process gas any more in portion 221, the provision of an evaporation area there is superfluous.

The heat transfer medium which heats up and, if appropriate, evaporates upon thermal contact with the process gas on the tubes of the tube bundle 222 flows into the subspace 211b. There, it then serves as heat transfer medium for cooling down the process gas in the portion 220, by being guided, as described above, through the shell and tube heat exchanger 225, 226. Overall, the operating temperature is thus higher in the portion 220 than in portion 221.

Moreover, it is conceivable (not shown here) for the condenser housing 202 to be subdivided not just into two portions 220, 221 but into three or more portions, in each of which are arranged tube bundles through which heat transfer medium flows in succession and which bring about thermal contact of the heat transfer medium with the process gas in so doing in the way described. Such portions may also be arranged one above another in the condenser housing.

Owing to the intense cooling of the process gas in the portion 221, the residual cold of the treated process gas can be utilized to cool down the untreated process gas in the portion 220. For this, in the exemplary embodiment according to FIG. 3, at least a partial stream of the process gas exiting at the carrier gas outlet 208 is fed via a line 228, indicated here only by a dashed line, to a tube bundle arranged in the portion 220 and acting as a recuperator 230, in that there the relatively cold, treated process gas is brought into indirect thermal contact with the relatively hot, untreated process gas. Moreover, such a recuperator can also be arranged somewhere else, for example upstream of the carrier gas inlet 207.

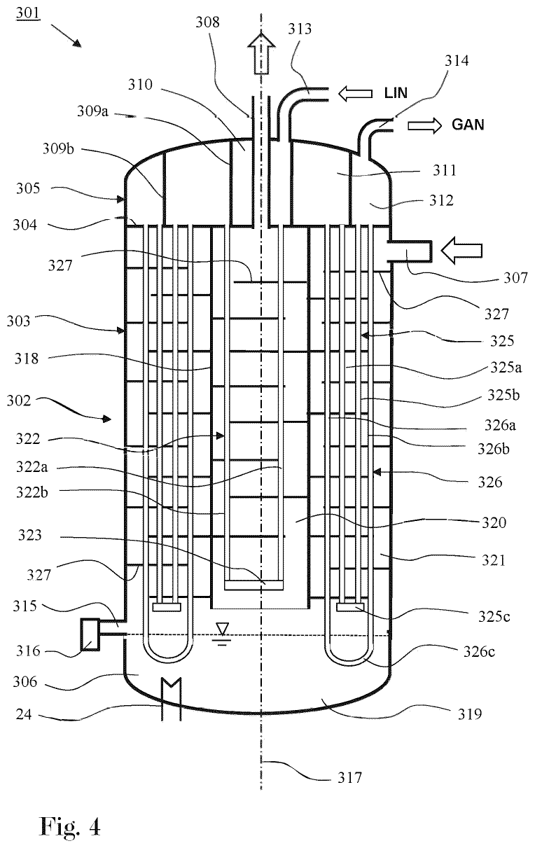

The device 301 shown in FIG. 4 is distinguished by a concentric arrangement of the tube bundles used as heat exchanger surfaces. Similarly to the exemplary embodiments shown above, the device 301 comprises a vertically arranged condenser housing 302, which has good thermal insulation and comprises a cylindrical central portion 303, a top portion 305 fluidically separated therefrom by a tube bottom 304, and a sump 306. A carrier gas inlet 307 leads in at the side of the central portion 303. A process outlet 308 passes through the top portion 305 and the tube bottom 304 and leads into the central portion 303 approximately in the middle of the tube bottom 304.

The top space 305 is subdivided by cylindrical and mutually coaxial partition walls 309a, 309b into mutually fluidically separate and concentrically arranged subspaces 310, 311, 312, specifically an inner subspace 310, a middle subspace 311 and an outer subspace 312. A feed line 313 for a heat transfer medium, in the exemplary embodiment shown here liquid nitrogen (LIN), opens into the inner subspace 310, and a discharge line 314 for the heat transfer medium, in the exemplary embodiment shown here gaseous nitrogen (GAN), that is heated and, in the process, possibly evaporated when the device 301 is in operation, leads into the outer subspace 312. The middle subspace 311 does not have a line connection to outside the condenser housing 302. The sump 306 is, as in the exemplary embodiments shown above, equipped with an overflow 315 and a gas barrier 316.

A separating tube 318, which extends inside the central portion 303 from the tube bottom 304 down to a level just above the overflow 315 and thus above a condensate bath 319 located in the sump 306 when the device 301 is in operation, is arranged concentrically with a longitudinal axis 317 of the central portion 303. The separating tube 318 subdivides the central portion 303 into two functional portions, an inner portion 320 and an outer portion 321, of which—in a similar way to the devices 101, 201—one portion (here portion 320) serves for removing the aerosols from the process gas, whereas a still-present residual loading in the process gas is reduced in a second portion (here portion 321).

A tube bundle 322, which fluidically connects the inner subspace 310 to the middle subspace 311 of the top space 305, is arranged in the inner portion 320. The tube bundle 322 has perpendicular tube bundle portions 322a, 322b, which are fluidically connected to one another at their lower ends by a tube bottom 323 or via curved tube bundle portions (not shown here). The tube bundle 322 extends down inside the central portion 303 only far enough not to be wetted by the condensate bath 319 when the device 301 is in operation; the tube bottom 323 is thus arranged vertically above the overflow 315.

Two tube bundles 325, 326, via which the middle subspace 311 and the outer subspace 312 of the top space 305 are fluidically connected to one another, are arranged in the outer portion 321. The tube bundles 325, 326 each have perpendicular tube bundle portions 325a, 325b; 326a, 326b, which are fluidically connected to one another at their lower ends via a tube bottom 325c or via tube bundle portions 326c curved in a U shape. The tube bundles 325, 326 extend to different depths in the condenser housing 302; while the tube bundle 325 does not go down further than a level just above the sump 306, the outer tube bundle 326 extends deeply into the sump 306 underneath the level of the overflow 315 by way of the tube bottom portion 326c. Moreover, the respective tube bundles 322, 325, 324 constructed from a plurality of mutually parallel tubes are also indicated only by individual tubes in FIG. 4, in particular the tube bundles 322, 325, 326 extend around the entire circumferential direction of the central portion 303 by way of a multiplicity of tubes.

Furthermore, a plurality of crescent-shaped, or circular-ring-shaped, baffle plates 327 are arranged both in the inner portion 320 and in the outer portion 321 of the central portion 303. The baffle plates 327 force a process gas guided through the respective portion 320, 321 into a meandering flow path, wherein the process gas is guided downward in the outer portion 321 and upward in the inner portion 320.

When the device 301 is in operation, a process gas laden with a substance to be condensed out flows via the carrier gas inlet 307 into the condenser housing 302 and leaves same at the carrier gas outlet 308. The gas barrier 316 prevents process gas from flowing out via the overflow 315.

In the outer portion 321, the process gas is forced radially into a meandering flow path by the baffle plates 327. In the process, with each reversal in flow it comes into contact with the tube bundle portions 326a, 325a, 325b, 326b (with a radially outward flow) or the tube bundle portions 326b, 325b, 325a, 326a (with a radially inward flow) in succession. Upon thermal contact on the tube bundle portions 326a, 325a, 325b, the process gas is cooled down to below the condensation temperature of the substance with which it is laden. As a result, the substance accumulates on the tube bundle portions 326a, 325a, 325b and consequently flows out into the condensate bath 319 in the sump 306. At the same time, undesired aerosols containing the substance to be condensed out form in the surroundings of the tube bundle portions 326a, 325a, 325b.

The heat transfer medium meanwhile flows in parallel through the tube bundles 325, 326 to the subspace 312 and is discharged via the discharge line 314. Since the curved tube bundle portion 326c of the tube bundle 326 extends through the condensate bath 319, the heat transfer medium guided through the tube bundle 326 comes into thermal contact there with the liquid condensate and heats up as a result; at the same time, the condensate in the sump 306 is cooled down. The heat transfer medium guided through the tube bundle portion 326b is therefore at a higher temperature than the heat transfer medium guided through the tube bundle portions 325a, 325b and 326a is. As a result, after each change in direction of the process gas in the region of the tube bundle portion 326b heating of the process gas cooled down beforehand on the tube line portions 325a, 325b and 326a occurs, and aerosols that had formed beforehand evaporate and are fed for condensation again.

After flowing through the outer portion 321, the process gas flows into the inner portion 320, in which it is cooled down to a very low temperature on the tube bundle 322, which acts as a cryogenic heat exchanger. In the process, it is forced into a meandering course again by baffle plates 327, wherein after each change in direction it comes into contact with the tube bundle portions 322a, 322b. At the same time, a cryogenic, preferably liquefied heat transfer medium, for example liquid nitrogen, is fed into the tube bundle portion 322a via the inner subspace 310 of the top space 305, flows through the tube bundle portion 322b and thus enters the middle space 311 of the top space 305. In the process, the process gas is cooled down on the tube bundle 322 to a temperature lower than the temperature of the process gas on the heat exchanger surfaces 325a, 325b and 326a in the outer portion 321. At the same time, the heat transfer medium in the tube bundle 322 evaporates owing to the thermal contact with the process gas. Since there are as good as no aerosols in the process gas any more in the inner portion 320, the provision of an evaporation area there is superfluous.

The treated process gas lastly flows out via the process gas outlet 308. Because it is still at a low temperature, it is also optionally possible here to connect a recuperator (not shown here) upstream of the device 301 or to integrate a recuperator in the apparatus in which the treated process gas is brought into thermal contact with the untreated process gas.

The device 301 enables particularly efficient operation, since the tube bundle 322 operated at the lowest temperature is arranged radially on the inside and the tube bundle portion 326b operated at the highest temperature is arranged radially on the outside. As a result, losses of cold owing to the unavoidable input of heat through the wall of the condenser housing 302 are mitigated. With certain objects, it is even possible to dispense with thermal insulation of the condenser housing 302. The radially symmetrical arrangement of the tube bundles 322, 325, 326 additionally simplifies the flow path of the process gas and makes it possible to come closer to equilibrium loading in a better way, as a result of which the degree of separation increases.

Moreover, within the context of the invention the vertical structure shown in the exemplary embodiments shown here is not in any way imperative; other arrangements are also conceivable, for example condensers with a horizontal housing. Furthermore, the devices 1, 101, 201 and 301 may each be equipped with a process control unit, not shown here, by means of which the fed mass flows of process gas and heat transfer medium can be regulated in accordance with the respective object.

### LIST OF REFERENCE SIGNS

| | | | |
|---|---|---|---|
| 1 | Device | 111 | Subspace |
| 2 | Condenser housing | 112 | Subspace |
| 3 | Central portion | 113 | Feed line |
| 4 | Tube bottom | 114 | Discharge line |
| 5 | Top space | 115 | Overflow |
| 6 | Sump | 116 | Gas barrier |
| 7 | Carrier gas inlet | 117 | Tube bundle |
| 8 | Carrier gas outlet | 117a, 117b, 117c | Tube bundle portions |
| 9 | Partition wall | 118 | Tube bundle |
| 10 | — | 118a, 118b, 118c | Tube bundle portions |
| 11 | Subspace | 119 | Partition wall |
| 12 | Subspace | 120 | Portion |
| 13 | Feed line | 121 | Portion |
| 14 | Discharge line | 122 | Baffle plate |
| 15 | Overflow | 123 | Condensate bath |
| 16 | Gas barrier | 124 | Evaporation area |
| 17 | Tube bundle | 201 | Device |
| 17a, 17b, 17c | Tube bundle portions | 202 | Condenser housing |
| 18 | Tube bundle | 203 | Central portion |
| 18a, 18b, 18c | Tube bundle portions | 204 | Tube bottom |
| 19 | Baffle plate | 205 | Top space |
| 20 | Flow path | 206 | Sump |
| 21 | Level | 207 | Carrier gas inlet |
| 22 | Condensate bath | 208 | Carrier gas outlet |
| 23 | Evaporation area | 209 | Partition wall |
| 24 | Heater | 210 | Partition wall |
| 101 | Device | 211a, 211b | Subspace |
| 102 | Condenser housing | 212 | Subspace |
| 103 | Central portion | 213 | Feed line |
| 104 | Tube bottom | 214 | Discharge line |
| 105 | Top space | 215 | Overflow |
| 106 | Sump | 216 | Gas barrier |
| 107 | Carrier gas inlet | 217 | — |
| 108 | Carrier gas outlet | 218 | Partition wall |
| 109 | Partition wall | 219 | Condensate bath |
| 110 | — | 220 | Portion |
| 221 | Portion | 309a, 309b | Partition wall |
| 222 | Tube bundle | 310 | Inner subspace |
| 222a, 222b | Tube bundle portion | 311 | Middle subspace |
| 223 | Tube bottom | 312 | Outer subspace |
| 224 | — | 313 | Feed line |
| 225 | Tube bundle | 314 | Discharge line |
| 225a, 225b, 225c | Tube bundle portion | 315 | Overflow |
| 226 | Tube bundle | 316 | Gas barrier |
| 226a, 226b, 226c | Tube bundle portion | 317 | Longitudinal axis |
| 227 | Baffle plate | 318 | Separating tube |
| 228 | Line | 319 | Condensate bath |
| 229 | — | 320 | Inner portion |
| 230 | Recuperator | 321 | Outer portion |
| 301 | Device | 322 | Tube bundle |
| 302 | Condenser housing | 322a, 322b | Tube bundle portion |
| 303 | Central portion | 323 | Tube bottom |
| 304 | Tube bottom | 324 | — |
| 305 | Top space | 325 | Tube bundle |
| 306 | Sump | 325a, 325b, 325c | Tube bundle portion |
| 307 | Carrier gas inlet | 326 | Tube bundle |
| 308 | Carrier gas outlet | 326a, 326b, 326c | Tube bundle portion |
| | | 327 | Baffle plate |

1. A method for separating a substance in gas or vapor form from a carrier gas stream by partial condensation, in the case of which method a carrier gas laden with at least one substance to be condensed out is guided along a flow path extending in the housing of a condenser from a carrier gas inlet to a carrier gas outlet, within which flow path said carrier gas is brought into indirect thermal contact with a heat transfer medium on a first heat exchanger surface and in the process is cooled down to a temperature below the dew point temperature of the substance to be condensed out, wherein the substance is deposited on the heat exchanger surface at least partially in the form of liquid condensate, which is then collected and discharged;
wherein, after contact with the first heat exchanger surface, the carrier gas flows through an evaporation area in the flow path, in which evaporation area a temperature higher than the dew point temperature of the substance to be condensed out prevails, and the carrier gas is then cooled down on a second heat exchanger surface in the flow path in indirect thermal contact with a heat transfer medium to a temperature below the dew point temperature of the substance to be condensed out.

2. The method as claimed in claim 1, wherein, as it flows through the flow path, the carrier gas is repeatedly in succession cooled down on a first heat exchanger surface or a group of first heat exchanger surfaces, then heated up in an evaporation area and cooled down again on a second heat exchanger surface or a group of second heat exchanger surfaces.

3. The method as claimed in claim 1, wherein the temperature in the evaporation area is maintained by an evaporation heat exchanger surface which is arranged in the evaporation area and on which the carrier gas is brought into indirect thermal contact with a heat transfer medium, the temperature of which is above the dew point temperature of the substance to be condensed out in the carrier gas.

4. The method as claimed in claim 3, wherein at least a partial stream of the heat transfer medium used on the first and/or the second heat exchanger surface, is brought into thermal contact with the collected condensate and then fed to the evaporation heat exchanger surface for indirect exchange of heat with the carrier gas in the evaporation area.

5. The method as claimed in claim 4, wherein, upon thermal contact with the heat transfer medium, the collected condensate is cooled down to a temperature at which re-evaporation of the condensate is avoided.

6. The method as claimed in claim 4, wherein the condensate and/or the heat transfer medium fed to the evaporation heat exchanger surface is heated up.

7. The method as claimed in claim 1, wherein the cooling medium used on the first heat exchanger surface and the cooling medium used on the second heat exchanger surface are taken from a common source.

8. The method as claimed in claim 1, wherein the heat transfer medium used on at least one of the heat exchanger surfaces is a liquefied gas, which at least partially evaporates owing to the indirect thermal contact with the carrier gas.

9. The method as claimed in claim 1, wherein at least a partial stream of the treated carrier gas is brought into thermal contact with the untreated carrier gas on a recuperator.

10. A device for separating a substance in the form of gas or vapor from a carrier gas stream by partial condensation, the device comprising:
a condenser, which has a housing, through which a flow path for a carrier gas laden with at least one substance to be condensed out extends between a carrier gas inlet and a carrier gas outlet, in which flow path are arranged a plurality of heat exchangers which are each equipped with a feed line and a discharge line for a heat transfer medium and with a heat exchanger surface for indirect thermal contact of the carrier gas with a heat transfer medium;
a unit for collecting and discharging the condensate of condensed-out substance that accumulates upon the indirect heat exchange;
a first heat exchanger with a first heat exchanger surface and a second heat exchanger with a second heat exchanger surface arranged at a spacing one behind the other in the flow path of the carrier gas—as viewed in the direction of flow thereof; and
means for heating up the carrier gas provided in an evaporation area arranged between the first heat exchanger surface and the second heat exchanger surface.

11. The device as claimed in claim 10, wherein more than two heat exchanger surfaces are arranged one behind the other in the flow path of the carrier gas and carrier gas flows along them in succession, wherein evaporation areas, in which the means for heating up the carrier gas are arranged, are arranged at least between some of the heat exchanger surfaces.

12. The device as claimed in claim 10, wherein the first heat exchanger and/or the second heat exchanger is/are in the form of a tube bundle through which a heat transfer medium flows.

13. The device as claimed in claim 12, wherein the flow path of the carrier gas is guided in meandering fashion around respective mutually parallel tube bundles of the first and the second heat exchangers.

14. The device as claimed in claim 10, wherein the means for heating up the carrier gas in the evaporation region comprise an evaporation heat exchanger equipped with a feed line and a discharge line for a heat transfer medium and also an evaporation heat exchanger surface.

15. The device as claimed in claim 14, wherein the feed line for the heat transfer medium of the evaporation heat exchanger is fluidically connected to the discharge line for the heat transfer medium of the first and/or the second heat exchanger, wherein the means for heating up the heat transfer medium are provided downstream of the heat exchanger surface of the heat exchanger, but upstream of the evaporation heat exchanger surface.

16. The device as claimed in claim 15, wherein the means for heating up the heat transfer medium comprise a condensate bath, in which a heat exchanger surface for heating up the heat transfer medium is arranged.

17. The device as claimed in claim 16, wherein means for controlling the temperature of the condensate are provided in the condensate bath.

18. The device as claimed in claim 10, wherein a cryogenic heat exchanger is arranged downstream of the second heat exchanger in the flow path of the carrier gas.

19. The device as claimed in claim 14, wherein the heat exchanger surfaces of the first heat exchanger and/or of the second heat exchanger and of the evaporation heat exchanger are in the form of tube bundles which extend concentrically with one another at least in a portion of the condenser housing, wherein the tube bundles of the first heat exchanger and/or of the second heat exchanger are arranged radially on the inside of the tube bundle of the evaporation heat exchanger.
